(19) United States
(12) Patent Application Publication
(10) Pub. No.: US 2022/0277311 A1
(43) Pub. Date: Sep. 1, 2022

(54) A TRANSACTION PROCESSING SYSTEM AND A TRANSACTION METHOD BASED ON FACIAL RECOGNITION

(71) Applicant: GENESISPRO PTE. LTD., Singapore (SG)

(72) Inventors: Adam HEGEDUS, Vienna (AT); Roland TRIMMEL, Oslip (AT)

(21) Appl. No.: 17/632,109

(22) PCT Filed: Aug. 5, 2019
(86) PCT No.: PCT/SI2019/050015

§ 371 Date: Feb. 1, 2022

(51) Int. Cl. G06Q 20/40

(52) U.S. Cl. CPC G06Q 20/40145

(57) ABSTRACT

The present invention belongs to the fields of data processing systems and methods, as well as payment protocols. The invention relates to a transaction processing system, preferably a payment system, and a transaction method based on facial recognition. The essence of the invention is that the customer is not required to perform any actions or gestures to confirm his/her liveness. In contrast liveness is passively checked by an algorithm incorporated in the system comprising a server hosting a customer database of personal profiles, a database of merchants, a transaction terminal having a camera or any other suitable device suitable for taking an image of a person, wherein the algorithm performs: —liveness analysis to ensure that the taken image is of a living person and not from a printed photo or a pre-filmed video; —retrieving of stored facial fingerprint of the customer from his profile; and—comparison of the obtained facial fingerprint from the taken image and the stored facial fingerprint to allow or reject the transaction.

### FIELD OF THE INVENTION

The present invention belongs to the fields of data processing systems and methods, as well as payment protocols based on recognition of facial fingerprints. The invention relates to a transaction processing system, preferably a payment system, and a transaction method based on facial recognition, which can be performed seamlessly, so without any further verification or a wallet or a phone, smart watch, nor any other wearable. A further aspect of the invention is a transaction terminal, preferably a payment terminal performing the mentioned method.

Transaction is in this application used to describe a process, in which user identification and/or verification occurs in order to allow finalization of a payment, a reservation, an order or collection of goods, for example from a postal worker or a car rental service. Thus, the term transaction is not only related to payment and banking processes, but also to accommodation reservations, rental car pickup, post collection or any other similar process that requires user identification and verification.

Facial recognition in the present application covers all aspects of recognizing a human's face and its specifics, which are covered by the term facial fingerprint. Face-drive and face-based recognition are synonyms of the term facial recognition and thus mean the same thing.

### BACKGROUND OF THE INVENTION AND THE TECHNICAL PROBLEM

The invention has been based on the need for a smooth and reliable payment system and method, however during its development is has been established that it can be used in a variety of other processes. But since the invention has been developed with payment application in mind, this background will be discussed. A payment system is used to settle financial transactions by transferring monetary value, the transfer including various institutions such as merchants and banks, people, rules, procedures, standards, and different technologies that make the exchange possible. A common type of payment system is a network that links bank accounts and provides for monetary exchange using bank deposits. The payment with a suitable instrument is only processed upon user identification and verification. Verification usually employs passwords such as PIN numbers, while official identification documents with probative value were previously used. Recently a new payment method has been developed, in which customer identification and verification is based on facial recognition, wherein identification and verification of the customer are two separate, consecutive steps.

Facial recognition is a process performed by facial recognition systems capable of identifying or verifying a person from a digital image or a video frame from a video source. There are multiple methods in which facial recognition systems work, but the essential part is to compare selected facial features, also called a facial fingerprint, with profiles saved in a database. This method is based on the finding that each face is unique and thus allows identification of a person by analysing patterns based on the person's facial textures and shape. Biometric passports also include results of such analysis.

Facial recognition is typically used as access control in security systems and can be compared to other biometrics such as fingerprint or eye iris recognition systems. Although the accuracy of facial recognition system as a biometric technology is lower than iris recognition and fingerprint recognition, it is widely adopted due to its contactless and non-invasive process. However, there are several safety issues as one could potentially use printed photos or pre-filmed videos of other people and consequently access their profiles. In order to increase the safety of facial recognition-based payment methods several different approaches have been used resulting in complicated procedures that are not desired in everyday purchasing in stores.

Thus, the technical problem, which is solved by the present invention, is to develop a primarily payment system and a payment method using facial fingerprint verification that has an easy and a reliable access to the database comprising user profiles and will allow simple and fast payments of purchases. Furthermore, the aim of this invention is also to provide a payment terminal that is able to support the said method. However, the invention has to be suitable for other use cases as well, where user identification and verification are needed.

### STATE OF THE ART

Patent application CN108090770 discloses a facial recognition-based POS machine payment system connected with a banking system. Said POS machine payment system includes a recognition module, a judgment module and a payment module, wherein the recognition module is used for facial recognition so as to obtain facial features and the judgment module is used for comparing recognized faces with faces collected by a bank card issuing bank; and the payment module pays corresponding funds after face image matching is successful. This solution differs from the present invention that profiles of customers are not stored in databases of banks. As the latter are not involved the presently disclosed payment method is less complicated.

Patent application CN109242490 discloses a payment information confirmation method based on facial recognition. A human face acquisition terminal, a remote terminal and a cloud processing platform constitute a payment system, the human face acquiring terminal provided with a touch control display screen for acquiring human face information. An identification device, a camera, an audio collecting device and a processor, wherein the processor is wirelessly connected with the cloud processing platform through a 4G network signal. The remote terminal confirms the payment information, the remote terminal can be a handheld electronic device, and the handheld electronic device is provided with a security password known only to the account owner. The present invention differs from this solution as it does not need an audio collecting device, because liveness of the customer is checked in a different manner.

Document CN109255618 discloses a facial recognition payment system performing information anti-counterfeiting method. The method comprises the following steps: extracting the dynamic video, extracting and comparing the facial image information of the payer, performing primary recognition, and performing secondary recognition according to the dynamic instruction randomly issued, thereby greatly improving the safety of the user's payment, and performing tertiary recognition through final terminal confirmation, so that the invention has extremely strong payment anti-counterfeiting performance and high payment safety.

Patent application CN108876354 describes a mobile payment device with a facial recognition function. With the mobile payment device with the facial recognition function, people can transmit a wireless signal to the payment device through the remote control device; payment information can be displayed on the payment device, and then, the payment device can immediately move to a position directly facing people; the position of the host is adjusted through the adjusting mechanism, so that the shooting mechanism directly faces a face; the payment is completed through a facial recognition technology. The shooting mechanism adopts three cameras to carry out facial recognition, and the face is repeatedly scanned, so that the recognition range is expanded, the recognition precision is enhanced, and the recognition deviation is avoided. This solution is complicated as it needs several cameras and processing of the data collected by them takes longer.

Document CN107742214 discloses a payment method comprising the following steps of performing face feature recognition, which gives a first recognition result; performing hand feature recognition, which results in a second recognition result; performing living body recognition that gives a third recognition result; wherein all recognition results generates an identity authentication result based on which the payment is executed. The present invention does not require the customer to perform gestures in order to confirm his/her liveness

Document CN106600855 discloses a payment method, which comprises the steps of: photographing a group of gestures and facial expressions of a user in advance; storing the group of gestures and facial expressions of the user; performing gesture and facial expression recognition when the user needs to perform safe payment, wherein the gesture and facial expression recognition is implemented by prompting the user to perform facial recognition so as to complement safe payment. The present invention does not require the customer to perform gestures in order to confirm his/her liveness.

Document CN103473676 describes a facial recognition payment system which comprises a face collection terminal and a payment centre server. The face collection terminal comprises a camera, a touch screen and a microprocessor. The camera is used for shooting face images, the touch screen is used for human-computer interaction, the microprocessor is used for pre-processing face images and performing data interaction with the server through a network. The server is used for performing comparison and judging whether face images shot by the camera are identical with face images pre-stored in advance.

Document CN103824068 discloses a human face payment authentication system comprising a module storing face data, a module for quality evaluation, a module for face posture correction, a facial recognition module and a payment module, wherein the face posture correction module is used for correcting deviated postures and the facial recognition module is used for extracting face feature information and comparing the face feature information with corresponding face feature in the database so as to judge whether the feature information belongs to the same person.

Unlike the above described known methods, the present invention provides a simpler and faster and less invasive verification of customers, as they are not commanded to make pre-defined human-like actions to prove his/her liveness, such as saying words or numbers out loud, turning head, blinking, smiling or other actions that tend to be very uncomfortable for the customer, especially if done in public settings.

### DESCRIPTION OF THE SOLUTION OF THE TECHNICAL PROBLEM

The essence of the present invention is that a transaction processing system, preferably a payment system, is provided that includes all necessary elements that allow customers identification and/or verification based on features of their face, wherein the customer is not required to perform any actions or gestures to complete a seamless payment transaction. In addition, the liveness of customers is checked to determine if the customer being captured is the actual measurement from an authorized live person at the time of capture. In summary, the system is able to verify the customer through facial recognition, passively detect the liveness of the customer, and seamlessly process the payment transaction. The term seamlessly means that the transaction is further processed without the need for any further verification such as a PIN number or human activity or a wallet or a phone, smart watch, nor any other wearable.

Transaction is in this application used to describe a process, in which user identification and/or verification occurs in order to allow finalization of a payment, reservation, an order or collection of goods, for example from a postal worker or a car rental service. Thus, the term transaction is not only related to payment and banking processes although this is the preferred embodiment of the invention, but also to accommodation reservations, rental car pickup, post collection or any other similar process that requires user identification and verification.

Facial recognition in the present application covers all aspects of recognizing a human's face and its specifics, which are covered by the term facial fingerprint. Face-drive and face-based recognition are synonyms of the term facial recognition and thus mean the same thing.

Liveness in this application means checking for the human to be alive and present at the place, where the transaction is supposed to occur, for example in a shop of any kind, in a hotel or any other accommodation premises, car rental service, etc.

Liveness thus denotes a process for checking that the image to be analysed for obtaining the facial fingerprint is not provided on a phone, camera or printed matter.

A merchant in this patent application means any kind of shop, accommodation providers, airlines and other providers of transport, car rental companies, postal and courier companies and similar. A merchant can also be an individual processing a transaction between individuals.

A database in this patent application can be hosted locally or in any other suitable means, including clouds. Customer and merchant database may be a single or a separated database.

The invention is built on machine learning and computer vision algorithms, which are operating in a server and/or a transaction terminal, preferably a payment terminal, that are a part of the transaction processing system. The said system comprises the following:
a server hosting:
   a customer database of personal profiles, each profile comprising at least the following:
      a facial fingerprint of the holder of the profile;
      personal information, for example name, address or other contact information of the holder of the profile;
      optionally information about at least one valid payment option and bank-related details such as credit card number, account number, crypto currency account and similar;
      optionally data of loyalty programs that the customer takes part in;
      optionally transaction history;
   and a database of merchants, each merchant profile comprising at least the following:
      name, address or other contact information of the merchant,
      optionally a list of accepted payment options comprising at least one payment option
      optionally banking details such as credit card number, account number, bank name and address, crypto currency and similar;
      optionally transaction history;
a transaction terminal, preferably a payment terminal comprising:
   a camera or any other suitable device suitable for taking a picture and/or a video of a person;
   a display and/or a touch screen or voice or gesture-controlled computer connected to the camera
   optionally a keyboard or a touch screen;
   wherein the preferred payment terminal allows at least one payment option, preferably several different payment options listed in the databases of customers and merchants, such as bank cards, credit cards, cryptocurrency, PayPal, etc.;
an algorithm integrated and executed by the server and/or the transaction terminal for performing at least the following:
   Registering new profiles into the database using a camera to capture customer's facial features, stored as single images (frames) or sets of images (frames) into the database, wherein the profile contains the necessary information such as personal data (names, addresses, date of birth, ID cards, account details, etc.), to process transactions, optionally payments and to reduce fraud;
   Retrieving the profiles of customers by sending pictures and/or videos of the customer to the database;
   normalize the face on the photo or short video so that it is prepared for and optimal facial analysis (i.e. removal of the background), for instance the part from the chin to the top of the head remains for analysis; and
   Passive testing of pictures and/or videos using liveness detection to ensure the captured image is an actual measurement from the authorized live person at the time of capture;
   using merchant and customer details to process the transaction, optionally the payment seamlessly, wherein the customer has an option to select different payment types (VISA, mastercard, bitcoin etc.,); and
   Optionally performing fraudulent analysis to alert customer and merchant of purchases that deviates from norm.

The server is a computer equipped and configured in such a way to be able to store and process all information connected with both databases and the payment terminal. It should be provided with suitable antivirus and antitheft programs to ensure security of the data stored in the databases. Both databases are regularly updated and can be accessed by facial recognition and/or by username/password verification or in any other suitable way, wherein the merchant database is preferably accessed by username/password verification. When building the customer database and adding customer profiles, the following information should be saved: name, address, payment details, banking information, possible further security codes. Most importantly, the face of the customer is photographed when creating the profile and is preferably updated in regular intervals such as in 6 to 12 months to improve accuracy due to possible changes in customer's appearance. Customer database can be preferably accessed with a mobile application or a web application, which can be installed on the phone, tablet or computer of the user. The algorithm analyses the usual facial features, which are used to generate facial fingerprints. The software preferably identifies approximately 80 nodal points on a human face. In this context, nodal points are endpoints used to measure variables of a person's face, such as the length or width of the nose, the depth of the eye sockets and the shape of the cheekbones. The system works by capturing data for nodal points on a digital image of an individual's face and storing the resulting data as a facial fingerprint. Facial fingerprints are stored as single images or frames or a set of images/frames, which is basically a short video, or in any suitable format or file for further analysis. The facial fingerprint is then used as a basis for comparison with data captured from faces in an image or video.

The transaction terminal can be a payment terminal or any other device that processes information based on user identification and/or verification. This terminal can be either a POS, a mobile phone, a tablet, a computer, etc. and can be controlled by written input (for example typing on a keyboard or screen), by voice or by various gestures. The preferred embodiment of the transaction terminal is a payment terminal, preferably a POS terminal that is also connected to the server in such a way that it has access to the specific merchant profile in the merchant database and that it has access to any customer profile in the customer database upon successful facial recognition. Upon requested payment the payment terminal takes a photo, preferably a static photo or short video with a length of few seconds, of the customer and the algorithm run on the server and/or the payment terminal performs at least the following steps:
Upon activation of the camera, which takes the picture or video of the user, the algorithm removes the background, preferably by cutting the image to obtain only the face;
Performing liveness analysis to ensure that the taken image is of a living person and not from a printed photo or a pre-filmed video;
Analysing the taken image to obtain a facial fingerprint;
retrieving of stored facial fingerprint of the customer from his profile;
comparing the obtained facial fingerprint with the facial fingerprint stored in the database; and
allowing or rejecting the payment based on the comparison of the facial fingerprints, wherein the matching of the facial fingerprints must be at least 90%, preferably at least 95%, more preferably at least 98% for the payment to be successful.

Liveness analysis preferably includes analysis of reflection, geometrical distortion, facial distortion, colour differences, combination of the colour of the landmark of the face, shearlet, chromatic and colour histogram, either alone or in any combination.

Although the payment process has been described, the same algorithm supports other uses, such as processing of accommodation reservations, collection of post, collection of rental cars and similar transactions. In this case, the transaction terminal, which can be also a mobile phone, a tablet or a computer, takes the image, connects to the server and the algorithm is run either on the terminal or the server.

By performing at least the above mentioned steps, the algorithm allows seamless transactions, preferably payments, wherein user identification and verification are combined in a single step. In contrast, previously known methods separated the steps of user identification and user verification, wherein verification was only possible upon entering a password, a PIN number, showing an ID document or similar. In order to ensure reliable operation of the system, the database of customers is preferably supplied in regular periods with new images or new facial fingerprints, as a customer's face may change with time. The periods can be from one month to every 5 or even 10 years, but the preferred period to update the profile is from 6 months to 2 years.

A further quality control step may be performed by the algorithm, where the quality is ensured by discarding:
Faces that are not properly centred to camera's frame are not used, e.g. faces with missing parts,
Faces that do not directly face the camera,
Face images that are too bright or dark,
Too blurry images;

wherein intensity histograms and frequency variances are preferably used for the purpose of quality assessment.

Although further verification steps are not needed, they can be performed by the algorithm in order to further increase security, wherein after comparison of facial fingerprint an optional additional step for fraudulent analysis is performed by requesting further verification such as PIN number, location data or similar can be completed. The algorithm can optionally perform object recognition processes, wherein the transaction terminal or the server running the algorithm is programmed so that it can recognize a paper, a mask or a device such as a mobile phone being moved towards the transaction terminal, in order to prevent spoofing attempts in advance.

Ease of access to the account and payment of a purchase is ensured by the simple taking of the customer's photo and automatically checking its credibility. Security of the payment method is ensured with the liveness analysis and optional further verifications. Liveness detection is crucial to counteract any attempt for biometric spoofing where a potential user tries to perform a presentational attack on the biometrical photo of the user's face, for instance by presenting a photo, a video, a model of the user. Thus, the technical effect of the liveness detection algorithm in the system is providing security, easier access to the account/profile and most importantly allowing payment processing by the payment terminal and the system. To prevent any kind of biometrical spoofing a thorough liveness detection analysis of the selfie provided by the user is implemented in the system. The Liveness analysis can be performed in any suitable way, such as conventional liveness detection methods based on texture analysis and motion detection, for example Facebanx, BioID, Brivas, TrueFace.ai, MePIN, EverAI, Facetec, Face++.

A skilled person in computer programming is able to program the algorithm in any suitable way in order to allow execution of the above-mentioned steps/activities and communication with components of the transaction processing system according to the invention.

The system and the transaction processing method according to the invention can be used in the following manner:
A customer sets up an account that is stored in the customer database on the server, the account including his facial fingerprint;
A merchant sets up an account that is stored in the merchant database on the server; The customer comes to the merchant, which is a store, and wants to pay for the goods;
The payment terminal at the store takes an image of the customers face;
The algorithm performs liveness check and compares the obtained facial fingerprint with the facial fingerprint stored in the database; and
In case of matching facial fingerprints allows payment with the selected method that is accepted by the store and is available in the customer's profile.

A further use case is collection of a rental car or a postal parcel, wherein:
A customer sets up an account that is stored in the customer database on the server, the account including his facial fingerprint;
A merchant sets up an account that is stored in the merchant database on the server; The merchant, which is a courier service or rental car service, requests identification and verification of the customer wanting to pick up the parcel or the car;
The transaction terminal provided by the courier service or rental car service takes an image of the customers face;
The algorithm performs liveness check and compares facial fingerprints; and
In case of matching facial fingerprints allows collection of the parcel or the car.

Another possible use is reservation and payment of a hotel, wherein:
A customer sets up an account that is stored in the customer database on the server, the account including his facial fingerprint;
A merchant sets up an account that is stored in the merchant database on the server;
The merchant, which is a hotel, requests identification and verification of the customer wanting to check in into the hotel;
The transaction terminal provided by the hotel takes an image of the customers face;
The algorithm performs liveness check and compares facial fingerprints; and
In case of matching facial fingerprints allows check-in into the hotel without the need for any other identification and/or verification steps or devices.

After the stay, the customer may pay for the hotel in the same way as described above when the customer is in a store.

In the scope of the invention as described herein and defined in the claims, other embodiments as well as uses of the transaction processing system and the transaction method based on facial recognition obvious to a skilled person are obvious. The discussed embodiments in no way limit the essence of the invention as described herein and in the claims.

The invention will be described in further detail based on possible embodiments and figures, which show:

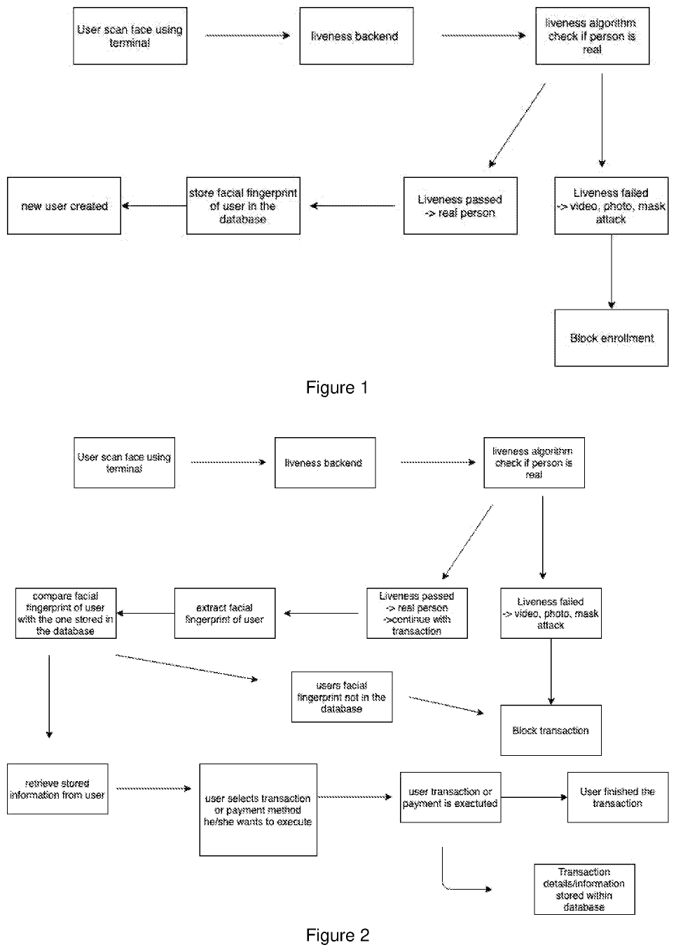

FIG. 1A flowchart showing creation of a new profile in the database of customers

FIG. 2A flowchart showing one embodiment of the payment method

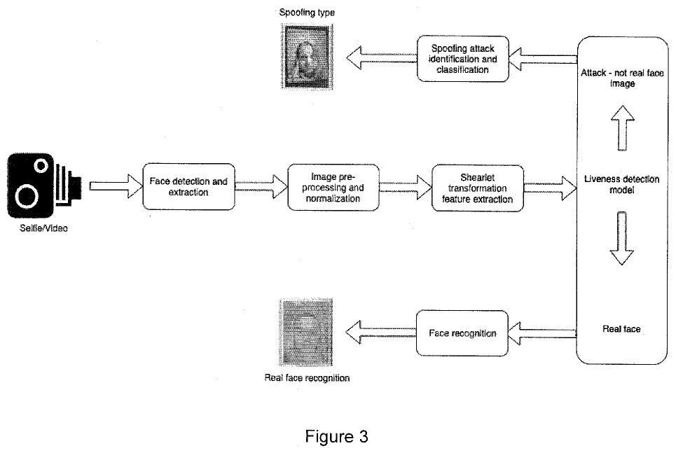

FIG. 3A flowchart of liveness analysis

FIG. 1 shows a flowchart showing creation of a new profile in the database of customers, wherein the following steps are performed: firstly, a customer's face is scanned and liveness of the customer is checked either online or offline with the liveness algorithm. In case the customer is proven to be alive (and not a printed image or pre-recorded video), the data are then stored, including the facial fingerprint. Lastly, other information is added to the profile, such as name of the customer, address, allowed payment methods and their details (bank cards, account number, bank, credit cards, cryptocurrency and cryptocurrency account/digital wallet, etc.). The profile can be set up on the transaction terminal, on a mobile phone, on a tablet, on a personal computer, via a mobile application or a web application, or in any other suitable way.

Similarly, also merchant's profile can be established in the respective database of merchants, wherein their profile does not need scanning of the face and liveness checking. Only information about the name, address and allowed payment methods and details connected with the latter have to be given and checked.

All information of all profiles is stored on a server or any other suitable means, including clouds, so that they can be accessed upon a payment request.

FIG. 2 shows a flowchart of a possible embodiment of the payment method performed on a payment terminal such as a POS terminal. Firstly, the POS is activated and its camera scans the face of a customer. The POS connects to the server to perform the analysis and connect to the profile in the database, wherein the liveness check can be performed by the server and/or the POS terminal. Identification of the customer and verification of his/her identity is performed in one single step, as upon analysis of facial fingerprints and liveness of the customer, the profile is accessed and the customer is allowed or denied to the profile. Access is denied in case the fingerprints are not matching the stored profile data and/or the customer has not passed the liveness requirement. In case of an allowed access, the customer can select the payment method listed in his profile and accepted by the merchant, and the payment is performed.

A more detailed embodiment of the payment method enabled by the above described payment system according to the invention comprises the following steps:
a) Activation of the payment terminal and connection to the server;
b) Requesting user verification and activating the camera or any other suitable device suitable for taking a picture and/or a video of the customer;
c) Taking a static or dynamic picture of the customer;
d) Analysing liveness of the picture taken in the previous step;
e) Analysing facial features in the picture taken in step c;
f) preferably accessing to the customer database and searching the closest profile based on facial features;
g) Comparing the facial fingerprint in the taken picture and saved picture;
h) Allowing access to selection of payment options if the comparison in step g) yielded a confirmation or denying access to selection of payment options if the said comparison found differences in facial fingerprints;
i) Execution of payment upon selected payment option in case of successful access.

Optionally an additional security step is performed prior to allowing access to selection of payment options, wherein this optional step comprises entering of a password or PIN number or any other verification method such as determination of location. Liveness analysis is preferably performed as described above. It preferably includes analysis of reflection, geometrical distortion, colour differences, combination of the colour of the landmark of the face, shearlet, chromatic and colour histogram, which allows accurate determinations whether the image is of a live person or a pre-printed or pre-filmed person. Quality control is ensured by discarding the following:
Faces that are not properly centred to camera's frame are not used, e.g. faces with missing parts,
Faces that do not directly face the camera,
Face images that are too bright or dark,
Too blurry images;
wherein intensity histograms and frequency variances are used for the purpose of quality assessment.

The payment terminal performing the described payment method comprises the following components:
a camera or any other suitable device suitable for taking a picture and/or a video of a person;
a keyboard and/or a touch screen or any other component needed for interaction with the user, such as a voice control module or gesture control module;
a screen wherein the payment terminal allows at least one payment option, preferably several different payment options listed in the databases of customers and merchants, such as bank cards, credit cards, cryptocurrency, PayPal, etc.

As described above liveness can be checked using any suitable method, however, the preferred embodiment uses a novel approach for mobile applications, which consists of a feature descriptor and a framework that uses a multiscale directional transformation known as shearlet transformation (FIG. 3). Multiple random forest classifiers comprise the machine learning component of the proposed solution, which is responsible for detecting potential spoofing attacks. Statistical properties of real face images are usually constant, whereas attack images contain multi-directional distortions. Shearlet constitutes a multiscale and multidirectional descriptor of face images; hence, it can effectively classify real faces and attack images.

Frames (images) are sampled, the face is then detected and extracted into a new image that is normalized. The normalization process uses common face landmarks to effectively position the face to the centre of the frame. The normalized image is transformed into an eight-bit image as the framework does not make use of colour features.

The Image Quality Assessment (IQA) module is responsible to filter the frames according to image quality characteristics. Too dark, bright or blurred images are discarded, as they are not appropriate for liveness detection. Shearlets are produced by the normalized images, and shearlet based features are subsequently extracted. Data is cleaned, prepared and transformed, to become in turn a training dataset for the creation of liveness detection models. According to this solution, images are decomposed into a fixed number of shearlets, which represent image information from single scale-direction viewpoint. Features are extracted from groups of shearlets and a known number of image descriptors/classifiers (which comprise a given face image) as used in trained prediction models that detect liveness.

Apart from the features extracted from the shearlets, there are some other optional methods that enhance the classifier's performance and reach to the desired levels of accuracy. One of the methods that will work in parallel with the shearlet feature extraction is the detection of micro-facial movements. The method for identifying micro-facial movements is commonly used to classify human emotions. Therefore, this is one of the most suitable methods to detect liveness on a short sequence of images. Along with specific spatiotemporal features that identify facial muscle movement, the extra information that we are incorporating in our classifier is minimising misclassifications and therefore the risk of false positives in our results.

Finally, the last method that may complete the system according to the invention is an eye tracking method that works to identify movements of the iris. This is mainly to identify with high accuracy photo attacks and offers a higher level of confidence on the overall result. Although it is not designed to identify mask attacks, but it covers any weaknesses the previous methods may have. Overall, all three methods can be combined to cover the total of the possible attacks and provide features that can lead to high accuracies in the final classification.

Classifier fusion techniques are applied to compose an optimum liveness detector, based on the inferences of the individual classifiers. The proposed machine learning approach is a supervised classification that is to identify an observation (face image) as a real face or a specific type of spoofing attack (e.g. paper-based attack, video-based attack, three-dimension model attack). The machine learning algorithm will have access to a training dataset that is split in images of two categories (classes). The first category is real (live) face images, while the second include a collection of images representing the spoofing attacks. The dataset is balanced with the same number of samples in order to avoid any biased classifiers. Feature extraction then collects the relevant features in order to train the machine learning algorithms on the training dataset. At the same time, a validation and testing dataset is used to ensure that the performance of the models is acceptable. Machine learning algorithms, appropriate for supervised classification, are random forests, support vector machines, and deep nets (using auto-encoders). Scikit-learn, TensorFlow (deep learning), OpenCV, and Weka frameworks are suitable to be used to implement the machine learning algorithms and realize liveness detection.

The system trained based on machine learning can be further trained to prevent any novel spoofing approaches. Thus, a reliable and constantly developing method of liveness detection is provided that can support safety of the payment method according to the invention. As discussed above the described embodiment may also be adapted to allow only identification and verification at the same time without performing a payment, so that for example a car rental or parcel pickup is allowed or denied based on analysed and compared facial fingerprints obtained from an image of a confirmed live person.

1. A transaction processing system based on facial recognition comprising the following:
a server hosting:
a customer database of personal profiles, each profile comprising at least the following:
a facial fingerprint of the holder of the profile;
personal information, for example name, address or other contact information of the holder of the profile;
optionally information about at least one valid payment option and bank-related details such as credit card number, account number, crypto currency account and similar;
optionally data of loyalty programs that the customer takes part in;
optionally transaction history;
and preferably a database of merchants, each merchant profile comprising at least the following:
name, address or other contact information of the merchant,
optionally a list of accepted payment options comprising at least one payment option
optionally banking details such as credit card number, account number, bank name and address, crypto currency and similar;
optionally transaction history;
a transaction terminal, preferably a payment terminal comprising:
a camera or any other suitable device suitable for taking a picture and/or a video of a person;
a display and/or a touch screen or voice or gesture-controlled computer connected to the camera
optionally a keyboard or a touch screen;
wherein the payment terminal optionally allows at least one payment option, preferably several different payment options listed in the databases of customers and merchants, such as bank cards, credit cards, cryptocurrency, PayPal, etc.;
an algorithm integrated and executed by the server and/or the transaction terminal for performing at least the following:
registering new profiles into the database using a camera to capture customer's facial fingerprint, stored as a single image or a set of images into the database, wherein the profile contains the necessary information such as personal data to process transactions, optionally payments;
upon activation of the camera on the transaction terminal, which takes the picture or video of the user, the algorithm normalizes the image for analysis, preferably by removing the background, most preferably by cutting the image to obtain only the face;
performing liveness analysis to ensure that the taken image is of a living person to prevent fraud for example by using a printed photo, a pre-filmed video or wearing mask;
analysing the taken image to obtain a facial fingerprint;
retrieving of stored facial fingerprint of the customer from his profile;
comparing the obtained facial fingerprint with the facial fingerprint stored in the database; and
allowing or rejecting the transaction based on the comparison of the facial fingerprints, wherein the matching of the facial fingerprints must be at least 90%, preferably at least 95%, more preferably at least 98% for the payment to be successful.

2. The transaction processing system based on facial recognition according to claim 1, characterized in that the algorithm analyses the usual facial features, which are used to generate facial fingerprints, preferably approximately 80 nodal points on a human face are analysed, such as the length or width of the nose, the depth of the eye sockets and the shape of the cheekbones, wherein captured data for nodal points on a digital image of a customer's face are storing as a facial fingerprint.

3. The transaction processing system based on facial recognition according to claim 1 or claim 2, characterized in that liveness analysis preferably includes analysis of reflection, geometrical distortion, facial distortion, colour differences, combination of the colour of the landmark of the face, shearlet, chromatic and colour histogram, either alone or in any combination.

4. The transaction processing system based on facial recognition according to any of the preceding claims, characterized in that the transaction is a process, in which user identification and/or verification occurs in order to allow finalization of a payment, reservation, an order or collection of goods, for example from a postal worker or a car rental service.

5. The transaction processing system based on facial recognition according to any of the preceding claims, characterized in that the transaction terminal can be a payment terminal or any other device that processes information based on user identification and/or verification.

6. The transaction processing system based on facial recognition according to the preceding claim, characterized in that the terminal can be either a POS, a mobile phone, a tablet, a computer, etc. and can be controlled by written input, for example typing on a keyboard or screen, by voice or by various gestures, preferably a POS terminal connected to the server in such a way that it has access to the specific merchant profile in the merchant database and that it has access to any customer profile in the customer database upon successful facial recognition, wherein upon requested payment the POS takes a photo, preferably a static photo or short video with a length of few seconds, of the customer and the algorithm run on the server and/or the POS.

7. The transaction processing system based on facial recognition according to any of the preceding claims, characterized in that the payment terminal comprises the following components:
a camera or any other suitable device suitable for taking a picture and/or a video of a person;
a keyboard and/or a touch screen or any other component needed for interaction with the user, such as a voice control module or gesture control module;
a screen,
wherein the payment terminal allows at least one payment option, preferably several different payment options listed in the databases of customers and merchants, such as bank cards, credit cards, cryptocurrency, PayPal.

8. The transaction processing system based on facial recognition according to any of the preceding claims, characterized in that a further quality control step may be performed by the algorithm, where the quality is ensured by discarding:
Faces that are not properly centred to camera's frame are not used, e.g. faces with missing parts,
Faces that do not directly face the camera,
Face images that are too bright or dark,
Too blurry images;
wherein intensity histograms and frequency variances are preferably used for the purpose of quality assessment.

9. The transaction processing system based on facial recognition according to any of the preceding claims, characterized in that after comparison of facial fingerprint an optional additional step for fraudulent analysis is performed by requesting further verification such as PIN number, location data or similar can be completed; and/or the algorithm can optionally perform object recognition processes, wherein the transaction terminal or the server running the algorithm is programmed so that it can recognize a paper, a mask or a device such as a mobile phone being moved towards the transaction terminal.

10. A transaction processing method performed by the system according to any of the preceding claims, the method comprises the following steps:
a) activation of the transaction terminal and connection to the server;
b) requesting user verification and activating the camera or any other suitable device suitable for taking a picture and/or a video of the customer;
c) taking a static or dynamic picture of the customer;
d) analysing liveness of the picture taken in the previous step;
e) analysing facial features in the picture taken in step c) in case liveness in step d) is proven;
f) comparing the facial fingerprint in the taken picture and saved picture;
g) allowing or denying the transaction;
h) and preferably execution of payment upon selected payment option in case of successful transaction.

11. The transaction processing method performed by the system according to the preceding claim, characterized in that creation of a new profile in the database of customers is performed in the following way:
firstly, a customer's face is scanned and liveness of the customer is checked either online or offline with the liveness algorithm
In case the customer is proven to be alive, the data are then stored, including the facial fingerprint,
lastly, other information is added to the profile, such as name of the customer, address, allowed payment methods and their details (bank cards, account number, bank, credit cards, cryptocurrency and cryptocurrency account/digital wallet, etc.),
wherein the profile can be set up on the transaction terminal, on a mobile phone, on a tablet, on a personal computer, via a mobile application or a web application, or in any other suitable way.

12. The transaction processing method performed by the system according to the preceding claim, characterized in that an additional security step is performed prior to allowing access to selection of payment options, wherein this optional step comprises entering of a password or PIN number or any other verification method such as determination of location.

13. The transaction processing method performed by the system according to the preceding claim, characterized in that liveness analysis preferably includes analysis of reflection, geometrical distortion, colour differences, combination of the colour of the landmark of the face, shearlet, chromatic and colour histogram, which allows accurate determinations whether the image is of a live person or a pre-printed or pre-filmed person.

14. The transaction processing method performed by the system according to the preceding claim, characterized in that liveness is performed as shearlet transformation, wherein shearlet constitutes a multiscale and multidirectional descriptor of face images; the liveness analysis comprising the following steps:
frames are sampled, the face is then detected and extracted into a new image that is normalized;
the normalization process uses common face landmarks to effectively position the face to the centre of the frame;
the normalized image is transformed into an eight-bit image as the framework does not make use of colour features;
the Image Quality Assessment (IQA) module is responsible to filter the frames according to image quality characteristics, wherein too dark, bright or blurred images are discarded;
shearlets are produced by the normalized images, and shearlet based features are subsequently extracted;
data is cleaned, prepared and transformed, to become in turn a training dataset for the creation of liveness detection models;
images are decomposed into a fixed number of shearlets, which represent image information from single scale-direction viewpoint;
features are extracted from groups of shearlets and a known number of image descriptors/classifiers (which comprise a given face image) as used in trained prediction models that detect liveness.
